(19) United States
(12) Patent Application Publication
(10) Pub. No.: US 2026/0361817 A1
(43) Pub. Date: Nov. 12, 2026

(54) DISTRIBUTED IN-MEMORY MAPPING ARCHITECTURE FOR SCALABLE REAL-TIME DATA STREAMING

(71) Applicant: Twilio Inc., San Francisco, CA (US)

(72) Inventors: Kentaro Kinebuchi, San Francisco, CA (US); Sergei Mihhailov, San Francisco, CA (US); Damir Fatkulin, San Francisco, CA (US); Hamza Salik, San Francisco, CA (US)

(21) Appl. No.: 19/202,257

(22) Filed: May 8, 2025

(51) Int. Cl. H04M 3/22; H04L 67/143

(52) U.S. Cl. CPC H04M 3/2272; H04L 67/143; H04M 2203/105

(57) ABSTRACT

Described herein are techniques for routing real-time data to websocket connections distributed across multiple server nodes. Each server node maintains a complete in-memory mapping table associating client identifiers with host node identifiers, eliminating external lookup dependencies. When a client establishes a websocket connection with a server node, connection information is published to a publish-subscribe system. All server nodes subscribe to this system, receiving updates to maintain current mapping tables. When an event needs delivery to a specific client, the receiving server performs an in-memory lookup to determine the target host (server) node, then forwards the event directly to that node. This architecture leverages the asymmetric nature of read/write operations in websocket routing systems, provides instantaneous lookups, self-heals during node failures, and significantly reduces operational costs while maintaining consistent low latency even at scale.

### TECHNICAL FIELD

The present application pertains to the technical field of distributed data routing systems, specifically addressing scalable and resilient architectures for managing real-time data streaming across multiple server nodes. The innovations described herein relate to an approach for efficiently routing event data to specific websocket connections distributed across multiple server nodes using in-memory mapping tables synchronized through a publish-subscribe system.

### BACKGROUND

Real-time data streaming architectures enable the rapid exchange of information across distributed computing environments. These architectures support various applications, including communication and messaging platforms, online gaming, financial trading systems, and telecommunications, where latency and scalability are key concerns.

In many such systems, events—such as incoming communication requests, state updates, or control messages—must be efficiently routed to the appropriate client devices. However, given the sheer number of clients in large-scale systems, ensuring that each event reaches the correct recipient in a timely manner presents a significant challenge. The complexity is compounded by the fact that client devices are often connected to different server nodes within a distributed infrastructure, and individual server nodes have finite capacity in terms of the number of concurrent client connections they can support.

### BRIEF DESCRIPTION OF THE DRAWINGS

Embodiments of the present invention are illustrated by way of example and not limitation in the figures of the accompanying drawings, in which:

FIG. 1 illustrates, in accordance with some embodiments, a cloud-based platform that enables efficient routing of real-time data between client devices and distributed server nodes, wherein multiple client devices establish bidirectional connections through a network to a connection management service that spans multiple server nodes.

FIG. 2 illustrates, in accordance with some embodiments, a distributed data routing system that implements an architecture for routing real-time data and events to specific websocket connections across multiple server nodes, wherein each event router maintains an in-memory mapping table associating client identifiers with connection server identifiers.

FIG. 3 illustrates, in accordance with some embodiments, a flowchart showing a method for managing websocket connections in a distributed system, including establishing connections, publishing connection information, distributing that information to server nodes, updating in-memory mapping tables, monitoring node health, and handling node failures.

FIG. 4 illustrates, in accordance with some embodiments, a flowchart showing a method for routing events to specific clients in a distributed system, including receiving a data event with a target client identifier, performing an in-memory lookup to determine the target host node, forwarding the event to that node, and verifying successful delivery.

FIG. 5 illustrates a block diagram showing an example software architecture that may be installed on devices implementing aspects of the present disclosure.

FIG. 6 illustrates a block diagram showing example components of a machine able to read instructions from a machine-readable medium and perform any of the methodologies discussed herein.

### DETAILED DESCRIPTION

Described herein are techniques for efficiently routing real-time data to specific websocket connections distributed across multiple server nodes in a scalable and resilient architecture. The techniques enable instantaneous lookups by maintaining in-memory mapping tables at each node that associate client identifiers with their corresponding host server nodes, eliminating the need for a centralized external lookup system. This distributed architecture leverages a publish-subscribe system to synchronize connection information across all host server nodes, ensuring that each node maintains a complete and current replica of the global mapping table. The system is self-healing when nodes fail, as clients automatically reconnect to available nodes and publish their new connection information, which is then propagated to all nodes in the system. In the following description, numerous specific implementation details are provided to enable a thorough understanding of the various aspects and embodiments of the invention, including techniques for managing websocket connections, methods for maintaining and synchronizing mapping tables, and approaches for handling node failures and system recovery. It will be apparent to one skilled in the art, however, that the present invention may be practiced without these specific details, and that various modifications and alterations may be made without departing from the broader spirit and scope of the invention.

Real-time data streaming systems have become increasingly important in modern communication platforms, enabling applications to deliver time-sensitive information to users with minimal delay. These systems typically employ websocket connections to maintain persistent communication channels between clients and servers, allowing for immediate delivery of data as data-driven events occur.

In large-scale deployments, such as communication platforms or contact center platforms where agents interact with customers in real-time, the ability to efficiently route real-time data to specific clients is important. These platforms often provide features such as real-time transcription of voice calls, instant messaging, and supervisor monitoring capabilities, all of which rely on the timely delivery of data to the appropriate recipients, via their respective client applications and devices.

As the number of simultaneous client connections in these systems grows into the hundreds of thousands, architectural considerations become increasingly important. Individual server nodes can typically support only a limited number of websocket connections due to operating system constraints related to TCP connections and system resources. This limitation necessitates distributing connections across multiple nodes in a server fleet.

In distributed websocket architectures, when data needs to be delivered to a specific client, the system must determine which server node currently hosts the connection to the specific client. This routing challenge is fundamental to maintaining the real-time nature of these applications, particularly in scenarios where latency requirements are stringent.

Various approaches to managing connection routing have emerged in the industry, including external lookup tables, caching mechanisms, and broadcasting strategies. Each approach represents different trade-offs between performance, resilience, scalability, and operational costs. The field continues to evolve as organizations seek more efficient ways to handle increasing volumes of real-time data while maintaining consistent performance and reliability across their distributed systems.

Several approaches have been developed to address this routing challenge, each with significant technical limitations. One common approach involves implementing an external database table (e.g. using DynamoDB®) to store mappings between client identifiers and host identifiers. When an event occurs and data is to be communicated to a specific client, the system performs a lookup in this table to determine the appropriate destination node, using a client identifier. However, this approach introduces several critical technical challenges. DynamoDB® and other similar databases have partitions with inherent throughput limitations, for instance, with constraints of approximately 3,000 reads per second and 1,000 writes per second, per partition. For systems requiring millions of reads per second, complex partitioning schemes become necessary, introducing additional complexity and potential points of failure. Furthermore, the cost implications of the DynamoDB® approach are substantial and can become prohibitive at scale.

Beyond cost considerations, the DynamoDB® approach introduces a critical external dependency that compromises system resilience. If the database service experiences an outage, the entire data routing system fails, preventing critical data and events from reaching their intended recipients. This creates a single point of failure in what should ideally be a highly distributed and resilient system.

The ephemeral nature of websocket connections further complicates the DynamoDB® approach. While websocket connections are transient, with clients connecting and disconnecting frequently, DynamoDB® storage is persistent. This mismatch necessitates implementing complex logic to clean up stale entries in the database table, introducing additional potential points of failure. The system must carefully manage this cleanup process to prevent the accumulation of invalid mappings while ensuring that valid mappings are not prematurely removed.

Performance considerations also limit the effectiveness of the DynamoDB® approach. Each event delivery requires a lookup operation in the external database, introducing latency that can be variable and unpredictable. For applications requiring consistent low-latency delivery, such as real-time voice transcription or financial trading platforms, this variability can significantly impact user experience and application functionality.

An alternative approach involves using Redis® instead of DynamoDB® for the lookup table. While this approach may address some of the latency concerns associated with DynamoDB®, it still suffers from many of the same fundamental problems. The system remains dependent on an external lookup mechanism that can fail, and the cost and complexity of maintaining this external system persist. The Redis® approach represents an incremental improvement rather than a fundamental solution to the routing challenge.

A third approach involves creating an autonomous cluster where each node handles both websocket connections and data ingestion. While this eliminates the need for external storage, it creates inefficiencies in resource utilization and introduces scaling challenges. The load on the underlying messaging system increases proportionally with the number of nodes in the cluster, as each node must consume all events regardless of relevance to its connected clients. This approach becomes increasingly inefficient as the system scales to support more connections and server nodes.

Some implementations attempt to address these challenges through cached broadcasting, where events are broadcast to all nodes when a mapping is not found in a local cache. This approach creates significant inefficiencies in network utilization and processing overhead, particularly as the system scales. The broadcasting approach essentially trades off precision for reliability, resulting in unnecessary data transmission and processing across the network.

The technical challenge in this domain is therefore to create a scalable, resilient architecture for routing real-time events to specific websocket connections that provides instantaneous lookups without external dependencies, maintains resilience when individual nodes or entire fleets fail, scales to support millions of simultaneous connections, minimizes operational costs, self-heals without manual intervention, and maintains consistent low latency throughout the system.

This challenge is further complicated by the asymmetric nature of the read and write patterns in such systems. The read rate for these mappings is exponentially higher than the write rate, as events are generated continuously while connection changes occur relatively infrequently. This creates a technical environment where the system must optimize for extremely high-volume, low-latency reads while efficiently handling a much lower volume of writes as connections are established and terminated.

Consistent with some embodiments, a distributed in-memory mapping architecture is provided that addresses the technical challenges of routing real-time data to specific websocket connections across multiple server nodes. The disclosed architecture and related techniques fundamentally transform the conventional approach to connection routing by eliminating external lookup dependencies and leveraging the asymmetric nature of read/write operations in websocket routing systems.

The architecture comprises a plurality of server nodes that maintain persistent websocket connections with clients. When a client establishes a websocket connection with a server node, that server node publishes connection information to a publish-subscribe system. This connection information associates a unique client identifier with the server node identifier that hosts the websocket connection for the specific client. All server nodes in the system subscribe to this publish-subscribe service, enabling each server node to receive updates about new connections, disconnections, and connection changes across the entire distributed system.

Each server node maintains its own complete in-memory mapping table that associates client identifiers with their corresponding host or server node identifiers. This mapping table is continuously updated based on the connection information received from the publish-subscribe system. By maintaining this mapping information in memory at each node, the distributed data routing system eliminates the need for external lookup operations that introduce latency and create single points of failure.

When a data event needs to be delivered to a specific client, the server node that receives the event performs an in-memory lookup in its local mapping table to determine which server node currently hosts the websocket connection for the target client. The event is then forwarded directly to the target server node, which delivers it to the client via the established websocket connection. This approach provides instantaneous lookups without the variable latency introduced by external database queries.

The publish-subscribe system serves as a mechanism for distributing connection information rather than as a lookup service itself. This distinction is important, as it allows the system to optimize for the asymmetric nature of read and write operations in websocket routing. The read rate for mapping lookups is exponentially higher than the write rate for connection changes, making in-memory lookups significantly more efficient than repeated external database queries.

In some embodiments, the publish-subscribe system is implemented using a distributed streaming platform such as Kafka®. When implemented with Kafka, the system leverages Kafka's ability to materialize a topic as a key-value table (K-table), which provides a persistent record of the current state of all websocket connections. This enables new server nodes to initialize their in-memory mapping tables by consuming the current state from the K-table when they join the system.

Consistent with some embodiments, the architecture is inherently self-healing when individual server nodes fail. If a server node hosting websocket connections goes down, the affected clients automatically reconnect to available server nodes. These new connections trigger the publication of updated connection information to the publish-subscribe system, which is then propagated to all server nodes. This ensures that the in-memory mapping tables across the system are automatically updated to reflect the new connection state without requiring manual intervention or complex cleanup processes.

Even in the event of a temporary outage of the publish-subscribe system itself, the architecture maintains operational continuity. Server nodes continue to route events using their existing in-memory mapping tables, which remain valid for all connections that haven't changed during the outage. When the publish-subscribe system recovers, the server nodes automatically resynchronize their mapping tables based on the connection information that becomes available.

The architecture also addresses the challenge of fleet-wide failures. If an entire fleet of server nodes needs to be replaced, the new fleet can initialize its mapping tables from the persistent state maintained in the publish-subscribe system. This eliminates the complex cleanup and migration processes required when using external databases for connection mapping.

In some embodiments, the system implements a hybrid approach to memory management. The mapping tables are primarily stored in memory for optimal performance, but the system can utilize disk storage as overflow when memory capacity is exceeded. This hybrid approach ensures that the system can scale to support millions of simultaneous connections without requiring excessive memory resources on individual server nodes.

The architecture significantly reduces operational costs compared to conventional approaches. By eliminating the need for external database services like DynamoDB® or Redis®, the system avoids the substantial costs associated with high-volume read operations. For example, a deployment supporting 150,000 agents with real-time data delivery capabilities might incur monthly costs of approximately $687 using this architecture, compared to tens of thousands of dollars for a DynamoDB-based solution handling the same load.

The architecture significantly reduces operational costs compared to conventional approaches. By eliminating the need for external database services like DynamoDB® or Redis®, the system avoids the substantial costs associated with high-volume read operations. For example, a deployment supporting a large number of agents with real-time data delivery capabilities might incur significantly lower monthly costs using this architecture, compared to a DynamoDB-based solution handling the same load.

The distributed in-memory mapping architecture is particularly well-suited for applications with stringent latency requirements, such as real-time voice transcription, financial trading platforms, and interactive gaming environments. By providing consistent low-latency routing without external dependencies, the system enables these applications to deliver time-sensitive data to users with minimal delay, enhancing the overall user experience.

In some embodiments, the architecture includes a “clean up” or monitoring component that detects when server nodes go down and publishes disconnection events to the publish-subscribe system. This proactive approach to node failure detection further enhances the resilience of the system by ensuring that all server nodes are promptly notified when a node becomes unavailable, allowing them to update their mapping tables accordingly.

The architecture is designed to scale horizontally by adding more server nodes as the number of client connections increases. With some embodiments, each server node can typically support some high, but not unlimited number (e.g., approximately 20,000) of websocket connections due to operating system constraints related to TCP connections and system resources. By distributing connections across multiple nodes and maintaining synchronized mapping tables, the system can scale to support hundreds of thousands or even millions of simultaneous connections while maintaining consistent performance.

This distributed in-memory mapping architecture represents a fundamental improvement over conventional approaches to websocket connection routing. By eliminating external dependencies, optimizing for asymmetric read/write patterns, enabling self-healing recovery, and reducing operational costs, the architecture provides a robust solution to the technical challenges of routing real-time data in large-scale distributed systems. Other aspects and advantages of the several embodiments will be readily apparent from the detailed descriptions of the several figures that follows.

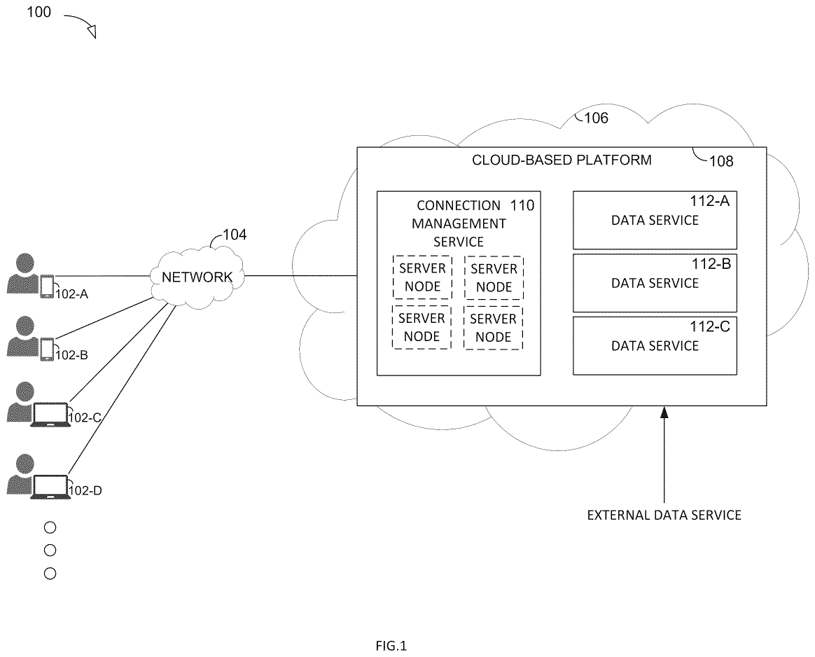

FIG. 1 illustrates a distributed computing environment 100 that enables efficient routing of real-time data between client devices and a cloud-based platform 108, consistent with embodiments. The system architecture addresses the challenge of managing large numbers of simultaneous client connections that exceed the capacity of any single server node.

Multiple client devices 102-A, 102-B, 102-C, and 102-D establish bidirectional websocket connections through a network 104 to the cloud-based platform 108. These client devices may represent various types of end-user equipment such as mobile phones, tablets, desktop computers, or specialized devices used in contact centers, financial trading platforms, gaming environments, or Internet of Things (IoT) applications.

The cloud-based platform 108 hosts various services that process and route data to and from the connected clients. Within this platform 108, the connection management service 110 is responsible for establishing and maintaining persistent websocket connections with the client devices. The connection management service 110 spans multiple server nodes, which is essential because individual server nodes have inherent limitations in the number of concurrent websocket connections they can support.

This limitation stems from operating system constraints related to TCP connections, file handles, and other system resources. Typically, a single server node can only support some high, but limited number (e.g., approximately 20,000) websocket connections due to these constraints. In large-scale deployments such as contact center platforms, financial trading systems, online gaming environments, or real-time collaboration tools, the total number of simultaneous connections can easily reach hundreds of thousands, necessitating distribution across multiple server nodes.

The cloud-based platform also includes multiple data services 112-A, 112-B, and 112-C that generate events and real-time data that need to be delivered to specific clients. These data services might include real-time transcription services for voice calls, financial market data feeds, game state updates, collaborative document editing notifications, or healthcare monitoring alerts. Additionally, external data services can also provide information that needs to be routed to specific clients, through the cloud-based platform 108.

When a data service needs to send information to a particular client, it must identify the target client using a client identifier. However, since the clients are distributed across multiple server nodes within the connection management service 110, the data service needs to determine which specific server node is currently hosting the connection for that client. This creates a fundamental routing challenge: how to efficiently map client identifiers to their corresponding host server nodes.

The client devices continuously connect and disconnect from the cloud-based platform due to various factors inherent in real-time communication systems. Websocket connections are ephemeral in nature, with clients attaching and disconnecting unpredictably due to network instability, client-side application closures, device power management, user behavior patterns, and intentional disconnections.

The architecture illustrated in FIG. 1 represents a solution to this routing challenge, enabling efficient delivery of real-time data across a distributed system of server nodes while maintaining low latency, high throughput, and system resilience. This approach is particularly valuable for cloud-based platforms that support applications such as contact centers, financial trading, multiplayer gaming, collaborative editing, IoT device management, and healthcare monitoring systems where real-time data delivery is critical to functionality.

In contrast to traditional approaches that use external lookup tables implemented with technologies like DynamoDB® or Redis® to map client identifiers to their corresponding server nodes, the architecture shown in FIG. 1 employs a distributed in-memory mapping approach. This eliminates external dependencies and provides instantaneous lookups without the variable latency introduced by external database queries.

The external data service shown at the bottom of FIG. 1 represents third-party systems that may trigger events requiring delivery to specific clients. These external services integrate with the cloud-based platform to provide complementary functionality and can initiate various types of real-time data delivery scenarios. For example, in a financial trading platform context, an external market data provider might detect a significant price change for a security that a particular trader has on their watchlist, requiring immediate delivery to the specific trader's interface.

This mapping solution is particularly important in environments with high volumes of real-time data, where latency requirements are stringent and system resilience is essential. By maintaining in-memory mapping tables at each node that associate client identifiers with their corresponding host nodes, the system eliminates the need for external lookup systems while ensuring that each node maintains a complete and current replica of the global mapping table.

In actual implementation, the cloud-based platform 108 could be any of several specific services where real-time data streaming is critical. For example, in a contact center platform, the cloud-based platform 108 might support real-time voice transcription services where audio from customer calls is converted to text and streamed to agent interfaces as the conversation progresses. In this context, data services 112-A, 112-B, and 112-C might generate transcription fragments, customer interaction analytics, and supervisor monitoring data that must be delivered to specific agent interfaces with minimal latency.

In a contact center environment, agents typically connect at the beginning of their shifts and disconnect at the end, creating predictable connection patterns. However, unexpected disconnections frequently occur due to network issues, browser crashes, or device failures. When the device of an agent disconnects, they must reconnect, often to a different server node based on current load balancing, requiring the system to update connection mappings accordingly. During peak hours, a contact center might experience hundreds of simultaneous connection and disconnection events as agents log in, take breaks, or experience technical issues, creating significant mapping challenges.

In financial trading platforms, the cloud-based platform might deliver real-time market data, trade confirmations, and price alerts to thousands of traders simultaneously. Here, the data services might include market data feeds, transaction processing systems, and algorithmic trading engines. Traders frequently connect from multiple devices throughout the day, switching between desktop workstations, tablets, and mobile phones as they move between meetings or trading floors, creating a complex pattern of connections and disconnections that the system must track efficiently.

For multiplayer gaming environments, the cloud-based platform 108 could manage game state updates, player actions, and in-game events across thousands of concurrent players. Players continuously connect and disconnect as they join or leave games, experience network interruptions, or switch devices. Gaming sessions can be particularly volatile, with players potentially connecting and disconnecting dozens of times during extended gameplay sessions, especially in mobile contexts where network conditions fluctuate.

In IoT applications, the cloud-based platform might monitor thousands of connected devices, routing sensor data, device status updates, and control commands between devices and monitoring interfaces. IoT devices frequently disconnect due to power conservation measures, network coverage issues, or maintenance cycles. For example, battery-powered sensors might connect only periodically to transmit readings before returning to low-power states, creating a continuous pattern of connections and disconnections that must be efficiently managed.

In healthcare monitoring systems, the cloud-based platform could route patient vital signs and medical device data to one or more monitoring devices of a healthcare provider. Medical staff frequently change locations throughout a hospital, connecting and disconnecting from different devices as they move between patient rooms, nursing stations, and break areas. The ephemeral nature of these connections contrasts with the critical importance of ensuring that urgent medical alerts are never lost due to connection state changes.

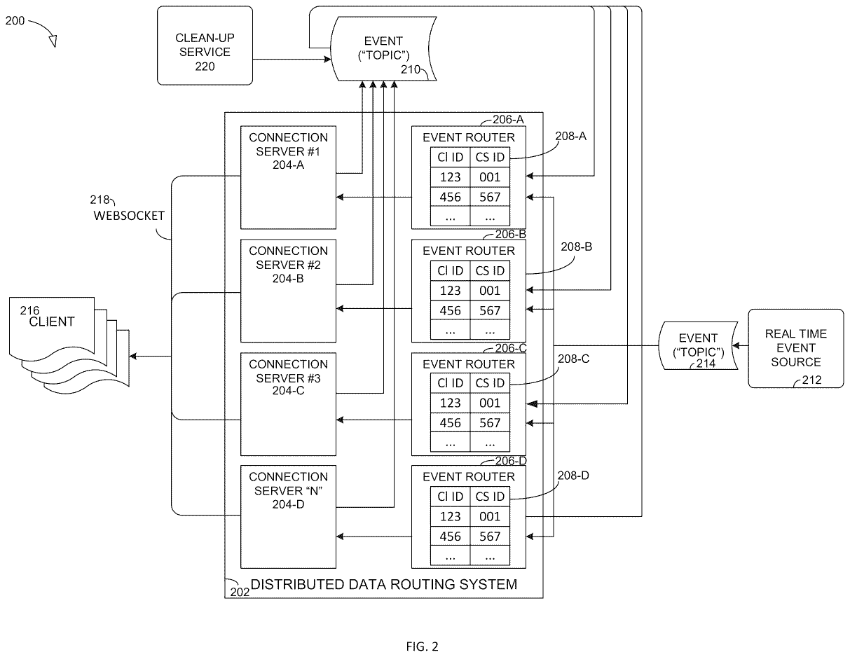

FIG. 2 illustrates a more detailed view of a distributed data routing system 202 that implements an efficient architecture for routing real-time events to specific websocket connections distributed across multiple server nodes, consistent with some embodiments. This system 202 addresses the fundamental challenge of delivering real-time data and event data to the appropriate clients when those clients are connected to different server nodes within a distributed infrastructure.

The distributed data routing system 202 includes multiple connection servers 204-A, 204-B, 204-C, and 204-D, each capable of maintaining websocket connections 218 with multiple clients 216. Each connection server can typically support some high, but limited, number of websocket connections due to operating system constraints related to TCP connections, file handles, and other system resources.

The system also includes multiple event routers 206-A, 206-B, 206-C, and 206-D, each maintaining an in-memory mapping table 208-A, 208-B, 208-C, and 208-D. These mapping tables store associations between client identifiers (e.g., “CI ID”) and connection server identifiers (e.g., “CS ID”), enabling instantaneous lookups to determine which connection server hosts a websocket connection for a particular client 216.

The in-memory mapping tables are a key innovation that eliminates the need for centralized and external lookup services (e.g., such as DynamoDB® or Redis®), which may be used in conventional distributed systems for connection routing. Each event router maintains a complete copy of the global mapping table in memory, allowing for significantly reduced latency when processing events. With some embodiments, the mapping is structured as a hash table where each entry contains a client identifier as the key and the corresponding connection server identifier as the value. This approach is particularly efficient because the read rate of these mappings is exponentially higher than the write rate in real-time communication systems.

Even with large-scale deployments supporting hundreds of thousands of simultaneous connections, the memory footprint remains manageable. If memory constraints become an issue, the system can implement a hybrid approach where frequently accessed mappings are kept in memory while less frequently accessed ones are stored on disk, providing an optimal balance between performance and resource utilization. This self-healing architecture ensures that if a node goes down, the system continues to function with minimal disruption, as each node contains the complete routing information needed to process events.

A publish-subscribe service, represented in FIG. 2 in part by the event topics 210 and 214, facilitates the synchronization of connection information across all event routers in the system. When a client establishes a websocket connection with one of the connection servers, that server publishes the connection information to the event topic 210, which distributes this information to all event routers in the system. For example, the event topic might be a “Topic: Websocket Connection” that specifically handles connection and disconnection events for all clients in the system. When publishing to this topic, the connection server provides specific information including the client identifier (CI ID), the connection server identifier (CS ID) that the client is connected to, and a timestamp of when the connection was established. This information allows all event routers to maintain accurate and up-to-date mapping tables, ensuring that real-time events such as voice data, transcriptions, or chat messages can be instantly routed to the correct client without requiring external lookups.

Real-time events or real-time data originate from a real-time event source 212 and are published to an event topic 214. These events could include real-time transcription fragments from voice calls (e.g., “Topic: Transcription”), financial market updates, game state changes, or other time-sensitive data that needs to be delivered to specific clients with minimal latency.

The clean-up service 220 monitors the health of connection servers and helps maintain the integrity of the mapping tables when servers go offline or experience failures. This monitoring is implemented through a dedicated system that continuously checks the operational status of each connection server using heartbeat signals or health check protocols. When a connection server becomes unresponsive or reports degraded performance, the clean up service 220 proactively publishes disconnection events to the event topic 210 for all clients that were connected to the affected server. These disconnection events are then propagated to all event routers in the system, allowing them to update their in-memory mapping tables by removing stale entries associated with the failed server. This proactive approach to node failure detection enhances the resilience of the system by ensuring that all server nodes are promptly notified when a node becomes unavailable, preventing attempts to route events to non-functioning servers and facilitating faster recovery as clients reconnect to available servers.

The operation of the distributed data routing system 202 can be understood through several key scenarios. When a client 216 connects to the system 202, the following sequence occurs: First, the client 216 establishes a websocket connection 218 with one of the connection servers, for example, connection server 204-A. This connection is typically established through a load balancer that distributes connections across available servers.

Upon successful connection establishment, connection server 204-A publishes connection information to the event topic 210. This information includes the client identifier and the identifier of the connection server 204-A that now hosts this websocket connection for the specific client.

All event routers 206-A through 206-D subscribe to the event topic 210 and receive this connection information. Each event router updates its in-memory mapping table to reflect that client 216 is now connected to connection server 204-A. This ensures that every event router in the system maintains a complete and current replica of the global connection mapping.

When a real-time event targeted at client 216 arrives from the real-time event source 212, it is published to the event topic 214. This event topic can be implemented as a dedicated Kafka topic, such as a “Transcriptions” topic for voice call transcriptions, a “Tasks” topic for task routing events, or a “Notifications” topic for system alerts. The topic serves as a distribution mechanism for categorized real-time data, allowing the system to organize and route different types of events efficiently. One of the event routers, for example 206-B, consumes this event and needs to determine which connection server hosts the websocket connection of the target client.

Event router 206-B performs an in-memory lookup in its mapping table 208-B, which indicates that client 216 is connected to connection server 204-A. The event router then forwards the event directly to connection server 204-A, which delivers it to client 216 through the established websocket connection 218. The event being routed can take various forms depending on the application context. It may be a discrete data packet such as a task assignment notification, a message delivery confirmation, or a system alert. Alternatively, it could be part of a continuous stream of real-time data, such as transcription fragments from an ongoing voice call, financial market updates that change by the second, or real-time analytics being generated as a customer interaction progresses. For example, in a contact center environment, the event might be a real-time transcription fragment that needs to be displayed on an agent's interface as a conversation unfolds, allowing the agent to review what was said without interrupting the call flow. The architecture is designed to handle both discrete events and continuous data streams with consistent low latency, ensuring that time-sensitive information reaches the intended recipient with minimal delay.

If a client disconnects and reconnects to a different connection server, the new connection information is published to the event topic 210, and all event routers update their mapping tables accordingly. This ensures that subsequent events are correctly routed to the new connection server with which the client has established the new connection.

When a connection server fails or goes offline, several mechanisms ensure system resilience. For example, if connection server 204-C fails, all clients connected to it will detect the disconnection and attempt to reconnect to other available connection servers in the system. As these clients reconnect to other servers, such as 204-A, 204-B, or 204-D, these servers publish the new connection information to the event topic 210. All event routers receive these updates and modify their mapping tables to reflect the new connection locations.

The clean up service 220 monitors the health of connection servers and can publish disconnection events for all clients that were connected to a failed server. This helps ensure that the mapping tables do not contain stale entries for connections that no longer exist.

In contrast to traditional approaches that use external lookup tables like DynamoDB® or Redis®, this architecture eliminates external dependencies by maintaining the mapping information in memory at each event router. This provides several advantages: lookups are instantaneous since they do not require external database queries; the system is more resilient because it can continue to function even if the publish-subscribe service experiences a temporary outage; and operational costs are significantly reduced by eliminating the need for external database services.

For example, in a contact center environment or communications platform where agents handle customer calls, real-time transcription fragments need to be delivered to the correct agent interface with minimal latency. When a transcription event is generated for a specific call, the event router performs an in-memory lookup to determine which connection server hosts the websocket connection for the agent handling that call, then forwards the transcription fragment directly to that server for immediate delivery to the user interface of the client application for that agent.

If an agent has a web browser that crashes and the agent needs to reconnect, the agent might establish a new websocket connection with a different connection server. This new connection information is automatically propagated to all event routers, ensuring that subsequent transcription fragments are correctly routed to the agent's new connection without any manual intervention or system reconfiguration.

The self-healing nature of this architecture is particularly valuable in large-scale deployments. For instance, if a connection server hosting 20,000 websocket connections suddenly fails, those clients will automatically reconnect to other available servers. As they reconnect, the new connection information is published and propagated throughout the system, allowing event delivery to resume without requiring any cleanup of external databases or manual system recovery procedures.

This architecture is designed to handle the asymmetric nature of read and write operations in websocket routing systems. The read rate (looking up where to send an event) is exponentially higher than the write rate (updating connection information when clients connect or disconnect). By optimizing for high-volume, low-latency reads while efficiently handling a much lower volume of writes, the system can scale to support millions of simultaneous connections while maintaining consistent performance and reliability.

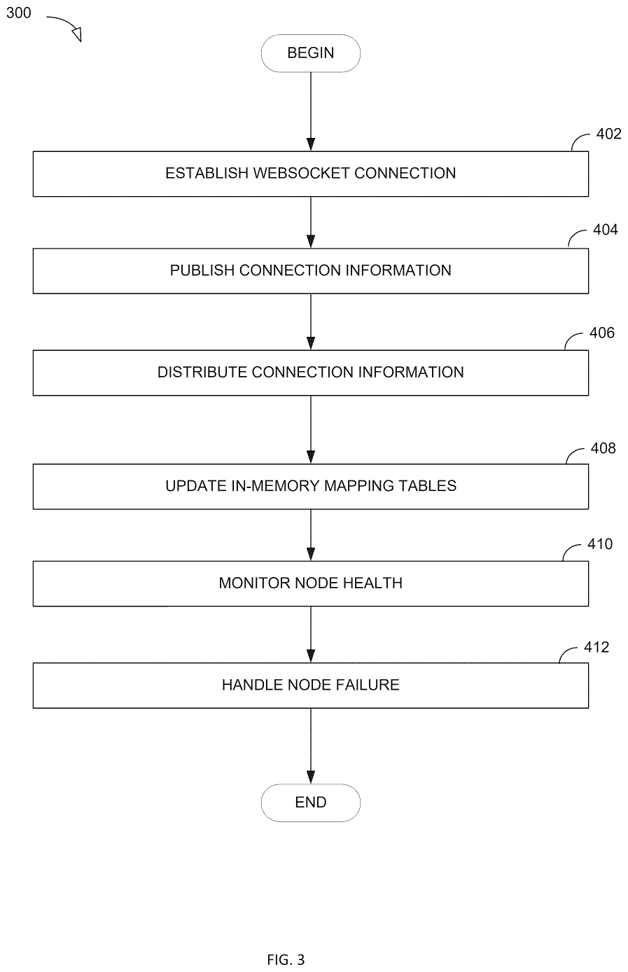

FIG. 3 illustrates, in accordance with some embodiments, a flowchart showing a method for managing websocket connections in a distributed system, including establishing connections, publishing connection information, distributing that information to server nodes, updating in-memory mapping tables, monitoring node health, and handling node failures.

At operation 302, a websocket connection is established between a client and a server node within the distributed system. This operation involves a client device initiating a connection request to one of the connection servers (e.g., 204-A through 204-D as shown in FIG. 2). The connection is typically established through a load balancer that distributes connections across available server nodes to ensure optimal resource utilization. Each server node can support a finite number of websocket connections due to operating system constraints related to TCP connections, file handles, and other system resources.

The websocket connection provides a persistent, bidirectional communication channel between the client and the server, enabling real-time data delivery with minimal latency. This persistent connection is essential for applications requiring immediate delivery of time-sensitive information, such as real-time transcriptions, financial alerts, or gaming updates.

Once the websocket connection is established at operation 304, the connection server publishes connection information to a publish-subscribe service. This connection information associates a unique client identifier with the server node identifier that now hosts the websocket connection for that specific client. The published information typically includes the client identifier (CI ID), the connection server identifier (CS ID), and potentially a timestamp indicating when the connection was established.

The publish-subscribe service can be implemented using a distributed streaming platform such as Kafka, which provides reliable message delivery and persistence. This operation is crucial as it enables the system to maintain an up-to-date record of which server node is hosting each client's websocket connection, information that is essential for proper event routing.

At operation 306, the connection information published in the previous step is distributed to all server nodes in the system. Each server node subscribes to the publish-subscribe service to receive updates about new connections, disconnections, and connection changes across the entire distributed system. This distribution mechanism ensures that all nodes maintain awareness of the global connection state without requiring direct communication between nodes.

The distribution process leverages the publish-subscribe architecture to efficiently propagate connection information with minimal overhead. This approach is particularly effective because it decouples the publishers (connection servers establishing new connections) from the subscribers (event routers needing to know connection locations), allowing the system to scale horizontally without increasing complexity.

Following the distribution of connection information, at operation 308, each server node updates its in-memory mapping table based on the received connection information. These mapping tables associate client identifiers with their corresponding host node identifiers, enabling instantaneous lookups when events need to be routed to specific clients.

The in-memory mapping tables are implemented as hash tables for efficient key-value lookups, with the client identifier serving as the key and the connection server identifier as the value. This approach optimizes for the asymmetric nature of read/write operations in websocket routing systems, where read operations (looking up where to send an event) occur at a significantly higher frequency than write operations (updating connection information).

If memory constraints become an issue, the system can implement a hybrid approach where frequently accessed mappings are kept in memory while less frequently accessed ones are stored on disk, providing an optimal balance between performance and resource utilization.

At operation 310, the system continuously monitors the health of all server nodes to detect failures or performance degradation. This monitoring can be implemented through a dedicated clean-up service (shown as element 220 in FIG. 2) that checks the operational status of each connection server using heartbeat signals or health check protocols.

The monitoring process is essential for maintaining system resilience, as it enables prompt detection of node failures and initiates appropriate recovery actions. By continuously tracking the status of all nodes, the system can proactively address potential issues before they impact service availability or performance.

When a node failure is detected through the monitoring process, operation 312 is triggered to handle the failure and maintain system continuity. This operation involves several steps to ensure that the system remains operational despite the loss of a server node.

First, when a connection server becomes unresponsive or reports degraded performance, the clean-up service proactively publishes disconnection events to the publish-subscribe service for all clients that were connected to the affected server. These disconnection events are then propagated to all event routers in the system, allowing them to update their in-memory mapping tables by removing stale entries associated with the failed server.

Simultaneously, clients that were connected to the failed server will detect the disconnection and automatically attempt to reconnect to other available server nodes. As these clients establish new connections, the new connection information is published and propagated throughout the system, updating the mapping tables accordingly.

This self-healing mechanism ensures that the system can recover from node failures without manual intervention, maintaining service continuity and data delivery even during partial outages. The architecture's resilience stems from its distributed nature and the redundancy provided by maintaining complete mapping information at each node.

The entire process illustrated in FIG. 3 represents a continuous cycle that enables the distributed system to efficiently manage websocket connections, route real-time data to specific clients, and maintain resilience in the face of node failures or other disruptions.

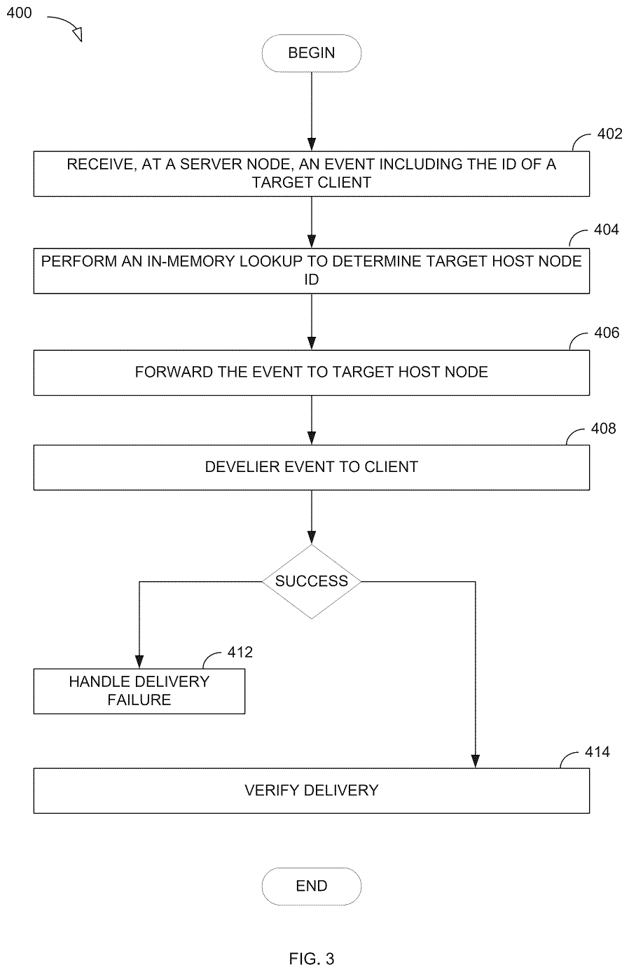

FIG. 4 illustrates, in accordance with some embodiments, a flowchart showing a method for routing events to specific clients in a distributed system, including receiving a data event with a target client identifier, performing an in-memory lookup to determine the target host node, forwarding the event to that node, and verifying successful delivery.

At operation 402, a server node receives an event that needs to be delivered to a specific client. This event typically originates from a real-time event source (element 212 in FIG. 2) and is published to an event topic (element 214 in FIG. 2) in the publish-subscribe system. The event contains a target client identifier that specifies which client should receive this particular event.

The event could represent various types of real-time data depending on the application context. In a contact center environment, it might be a real-time transcription fragment from an ongoing voice call that needs to be displayed on a user interface of a client application of an agent. In a financial trading platform, it could be a price alert or transaction notification. For gaming applications, it might be a game state update or player action notification.

One of the event routers (elements 206-A through 206-D in FIG. 2) consumes this event from the publish-subscribe system and initiates the routing process. The event router extracts the target client identifier from the event payload to determine where the event should be delivered.

At operation 404, the server node that received the event performs an in-memory lookup in its local mapping table to determine which connection server (host node) currently maintains the websocket connection with the target client. This lookup operation is instantaneous since it accesses data stored directly in the server's memory rather than querying an external database.

The in-memory mapping table (elements 208-A through 208-D in FIG. 2) contains associations between client identifiers and connection server identifiers. These tables are continuously updated based on connection information received from the publish-subscribe service, ensuring that they reflect the current state of all websocket connections in the system.

This approach significantly reduces latency compared to traditional methods that rely on external lookup services such as DynamoDB or Redis. By maintaining the mapping information locally in memory at each node, the system eliminates the variable latency introduced by external database queries, providing consistent low-latency event routing even at scale.

At operation 406, after determining which connection server hosts the websocket connection for the target client, the event router forwards the event directly to that server. This forwarding operation typically involves a direct server-to-server communication, transmitting the complete event payload to the appropriate connection server.

The forwarding mechanism is designed to be efficient and reliable, with built-in error handling to address scenarios where the target connection server might be temporarily unavailable or experiencing high load. If the initial forwarding attempt fails, the system may implement retry logic with exponential backoff to ensure eventual delivery of the event.

In cases where the target connection server has recently gone offline but the mapping table has not yet been updated, the forwarding operation may fail. In such scenarios, the system can either queue the event for later delivery or trigger a system-wide check to determine the current status of the client connection.

At operation 408, once the event has been successfully forwarded to the appropriate connection server, that server delivers the event to the target client through the established websocket connection. The delivery process involves serializing the event data in a format appropriate for websocket transmission and pushing it through the persistent connection to the client application.

The connection server may also perform additional processing before delivering the event, such as filtering based on client subscription preferences or transforming the data format to match client-side expectations. For example, in a contact center environment, the server might filter transcription events based on which specific calls an agent has subscribed to monitor.

The delivery operation is optimized for minimal latency, ensuring that time-sensitive information reaches the client as quickly as possible. This is particularly important for applications such as real-time voice transcription, financial trading platforms, or interactive gaming environments where delays can significantly impact user experience.

After attempting to deliver the event to the client, the system evaluates whether the delivery was successful. This evaluation may involve receiving an acknowledgment from the client application or monitoring the websocket connection status during the delivery attempt.

If the delivery is successful, the process continues to operation 414 for verification. If the delivery fails, the process branches to operation 412 to handle the failure appropriately.

At operation 412, if the event delivery fails, the system implements failure handling procedures to ensure system resilience and data integrity. Delivery failures can occur for various reasons, including temporary network issues, client disconnections, or server problems.

The failure handling process may involve several strategies depending on the nature of the failure and the requirements of the application. For transient failures, the system might queue the event for retry after a short delay. For persistent failures, it might store the event in a durable storage system for later retrieval when the client reconnects.

In cases where the failure indicates that the client has disconnected from the system entirely, the connection server publishes a disconnection event to the publish-subscribe service, allowing all event routers to update their in-memory mapping tables accordingly. This ensures that subsequent events for the same client are not routed to a connection that no longer exists.

For critical applications where event delivery guarantees are essential, the system might implement a dead-letter queue for failed deliveries, allowing administrative review and manual intervention if necessary.

At operation 414, after successful delivery of the event to the client, the system performs verification procedures to confirm that the event was properly received and processed by the client application. This verification may involve receiving explicit acknowledgments from the client or monitoring client behavior to infer successful processing.

The verification process helps maintain the reliability of the real-time data delivery system by ensuring that events are not only transmitted but also correctly processed at their destination. This is particularly important in mission-critical applications where data loss or corruption could have significant consequences.

Verification data may also be used to generate metrics and analytics about system performance, helping operators identify patterns of delivery issues or opportunities for optimization. These metrics might include delivery success rates, end-to-end latency measurements, and client processing times.

Upon completion of the verification process, the event routing operation is considered complete, and the system returns to its ready state to process subsequent events. The entire process from event reception to verified delivery is designed to occur with minimal latency, ensuring that real-time data reaches its intended recipients as quickly as possible while maintaining system resilience and scalability.

While many of the embodiments described herein utilize websocket connections as the bidirectional communication mechanism between clients and server nodes, the distributed routing architecture is not limited to websocket technology specifically. Consistent with various embodiments, the technical solution—maintaining in-memory mapping tables synchronized through a publish-subscribe system—can be implemented with any of a variety of real-time bidirectional communication protocols that enable persistent connections between clients and servers.

For example, the architecture could be implemented using Server-Sent Events (SSE), which establish a unidirectional connection from server to client for pushing updates while using standard HTTP requests for client-to-server communication. In this implementation, the in-memory mapping would track SSE connections rather than websocket connections, but the fundamental routing approach would remain unchanged.

Similarly, the system could leverage Long Polling techniques, where clients maintain persistent HTTP connections that remain open until the server has new data to send. The mapping tables would track these long-lived HTTP connections, with the same distributed in-memory approach ensuring efficient routing.

The architecture could also be implemented using MQTT (Message Queuing Telemetry Transport), a lightweight publish-subscribe protocol designed for constrained devices and low-bandwidth, high-latency networks. This would be particularly valuable for IoT applications where devices have limited processing capabilities but still require real-time data delivery.

WebRTC data channels represent another potential implementation, offering peer-to-peer communication capabilities with built-in encryption. The distributed routing system could manage WebRTC connection information in its in-memory tables, enabling secure real-time data exchange without relying exclusively on server-mediated communication.

Finally, the system could utilize gRPC with bidirectional streaming, which enables both clients and servers to send a sequence of messages using a single TCP connection. The in-memory mapping would track these streaming connections, providing the same benefits of low-latency routing while leveraging gRPC's efficient protocol buffer serialization.

Several of the embodiments presented herein utilize Apache Kafka as the publish-subscribe system that enables the distributed in-memory mapping architecture. Kafka is a distributed streaming platform that provides a high-throughput, fault-tolerant mechanism for handling real-time data feeds. It functions as a publish-subscribe messaging system where data streams are organized into topics, allowing producers to publish messages to these topics and consumers to subscribe to them. In the context of the invention, Kafka enables the synchronization of connection information across all server nodes by distributing websocket connection events through dedicated topics.

The architecture leverages Kafka's ability to materialize a topic as a key-value table (K-table), which provides a persistent record of the current state of all websocket connections. This feature is particularly valuable for initializing new server nodes, as they can consume the current state from the K-table when joining the system, ensuring they have complete mapping information without requiring complex synchronization procedures. Additionally, Kafka's resilience as a cluster-based system means it rarely experiences complete outages, contributing to the overall system reliability.

However, the invention is not limited to Kafka specifically and could be implemented using various alternative publish-subscribe systems that provide similar functionality. These alternatives might include Apache Pulsar, which offers multi-tenancy and geo-replication features; RabbitMQ, which provides robust message queuing capabilities; Amazon Kinesis, which integrates well with other AWS services; Google Pub/Sub for cloud-native applications; or NATS for lightweight, high-performance messaging. The core requirement is that the chosen system must support reliable message delivery, persistence of connection state, and efficient distribution of updates to all subscribing nodes. The fundamental innovation lies in the architectural approach of maintaining synchronized in-memory mapping tables across distributed nodes, not in the specific messaging technology employed.

Several of the embodiments presented herein involve a communications platform where websocket connections are used to connect end-user devices involved in communication sessions, such as voice calls between agents and customers. In these embodiments, real-time data like transcriptions are routed to specific clients through a distributed architecture that maintains in-memory mapping tables across multiple server nodes. While the architecture is particularly well-suited for communications platforms, the technical solution is not limited to such applications. The distributed in-memory mapping approach for routing real-time data to websocket connections can be leveraged across a variety of use cases where low-latency, resilient data delivery is required.

Financial trading platforms represent one potential application domain where this architecture could deliver significant value. In such environments, the system could be used to deliver real-time market data, trade confirmations, and price alerts to thousands of simultaneous traders. When a stock price changes or a trade executes, the system can route these time-sensitive notifications to the appropriate trader's interface with minimal latency, which is critical in financial markets where milliseconds can make substantial differences in trading outcomes.

Multiplayer gaming environments could also benefit from this architecture to route game state updates, player actions, and in-game events to thousands of concurrent players. The self-healing nature of the system would ensure continuous gameplay even if individual server nodes fail, providing a seamless experience for users even during partial system outages. This resilience is particularly valuable in competitive gaming scenarios where interruptions could significantly impact user experience.

For Internet of Things applications monitoring thousands of connected devices, the architecture could efficiently route sensor data, device status updates, and control commands between devices and monitoring interfaces. When a sensor reading exceeds a threshold or a device status changes, the system can instantly route this information to the appropriate monitoring dashboard. The architecture's ability to scale while maintaining consistent performance makes it well-suited for IoT deployments that may grow from hundreds to millions of connected devices over time.

Document editing platforms where multiple users simultaneously edit shared content could leverage this architecture to propagate changes in real-time across all participants. When one user makes an edit, the change can be instantly routed to all other users viewing or editing the document, maintaining consistency across all instances. The low-latency characteristics of the in-memory mapping approach would ensure that collaborative editing remains responsive even with large numbers of simultaneous users.

In healthcare monitoring systems, particularly in hospital environments where patient vital signs and medical device data need to be continuously monitored, this architecture could route critical alerts and real-time patient data to the appropriate healthcare providers'devices. The system's resilience would be particularly valuable in these life-critical applications, ensuring that important medical alerts are never lost due to system failures. The self-healing capabilities would provide an additional layer of reliability in environments where data delivery failures could have serious consequences.

### Software Architecture

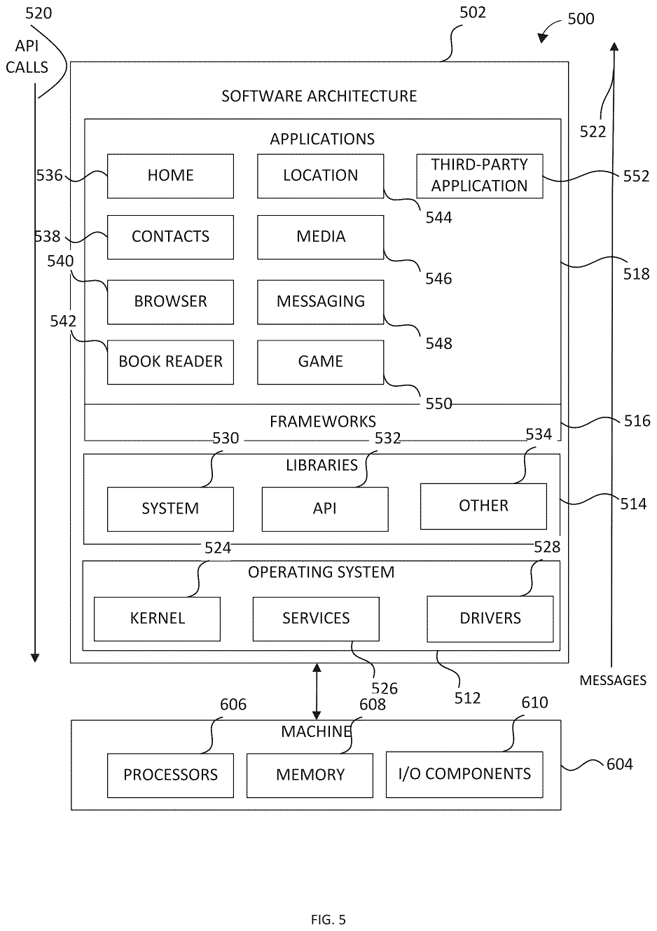

FIG. 5 is a block diagram 500 illustrating a software architecture 502, which can be installed on any one or more of the devices described herein. The software architecture 502 is supported by hardware such as a machine 604 that includes processors 606, memory 608, and I/O components 610. In this example, the software architecture 502 can be conceptualized as a stack of layers, where each layer provides a particular functionality. The software architecture 502 includes layers such as an operating system 512, libraries 514, frameworks 516, and applications 518. Operationally, the applications 518 invoke API calls 520 through the software stack and receive messages 522 in response to the API calls 520.

The operating system 512 manages hardware resources and provides common services. The operating system 512 includes, for example, a kernel 524, services 526, and drivers 528. The kernel 524 acts as an abstraction layer between the hardware and the other software layers. For example, the kernel 524 provides memory management, processor management (e.g., scheduling), component management, networking, and security settings, among other functionalities. The services 526 can provide other common services for the other software layers. The drivers 528 are responsible for controlling or interfacing with the underlying hardware. For instance, the drivers 528 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 514 provide a common low-level infrastructure used by the applications 518. The libraries 514 can include system libraries 530 (e.g., C standard library) that provide functions such as memory allocation functions, string manipulation functions, mathematical functions, and the like. In addition, the libraries 514 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 514 can also include a wide variety of other libraries 534 to provide many other APIs to the applications 518.

The frameworks 516 provide a common high-level infrastructure that is used by the applications 518. For example, the frameworks 516 provide various graphical user interface (GUI) functions, high-level resource management, and high-level location services. The frameworks 516 can provide a broad spectrum of other APIs that can be used by the applications 518, some of which may be specific to a particular operating system or platform.

In an example, the applications 518 may include a home application 536, a contacts application 538, a browser application 540, a book reader application 542, a location application 544, a media application 546, a messaging application 548, a game application 550, and a broad assortment of other applications such as a third-party application 552. The applications 518 are programs that execute functions defined in the programs. Various programming languages can be employed to create one or more of the applications 518, structured in a variety of manners, such as object-oriented programming languages (e.g., Objective-C, Java, or C++) or procedural programming languages (e.g., C or assembly language). In a specific example, the third-party application 552 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 552 can invoke the API calls 520 provided by the operating system 512 to facilitate functionalities described herein.

### Machine Architecture

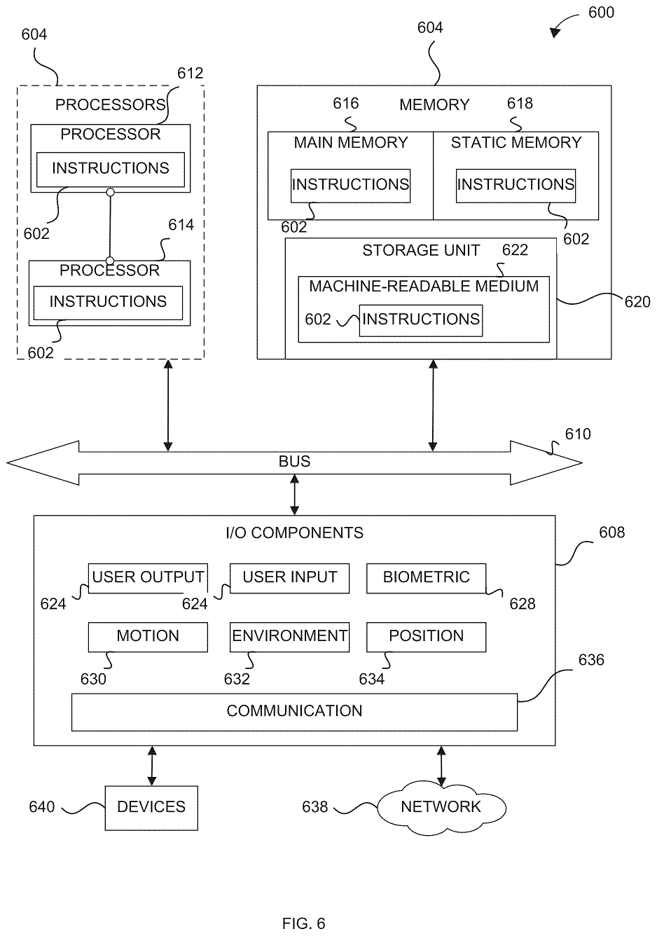

FIG. 6 is a diagrammatic representation of the machine 600 within which instructions 602 (e.g., software, a program, an application, an applet, an app, or other executable code) for causing the machine 600 to perform any one or more of the methodologies discussed herein may be executed. For example, the instructions 602 may cause the machine 600 to execute any one or more of the methods described herein. The instructions 602 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 602, sequentially or otherwise, that specify actions to be taken by the machine 600. Further, while a single machine 600 is illustrated, the term machine” shall also be taken to include a collection of machines that individually or jointly execute the instructions 602 to perform any one or more of the methodologies discussed herein. In some examples, the machine 600 may also comprise both client and server systems, with certain operations of a particular method or algorithm being performed on the server-side and with certain operations of the method or algorithm being performed on the client-side.

The machine 600 may include processors 604, memory 604, and input/output I/O components 608, which may be configured to communicate with each other via a bus 610.

The memory 606 includes a main memory 616, a static memory 618, and a storage unit 620, both accessible to the processors 604 via the bus 610. The main memory 606, the static memory 618, and storage unit 5620 store the instructions 602 embodying any one or more of the methodologies or functions described herein. The instructions 602 may also reside, completely or partially, within the main memory 616, within the static memory 618, within machine-readable medium 622 within the storage unit 620, within at least one of the processors 604 (e.g., within the processor's cache memory), or any suitable combination thereof, during execution thereof by the machine 600.

The I/O components 608 may include a wide variety of components to receive input, provide output, produce output, transmit information, exchange information, capture measurements, and so on. The specific I/O components 608 that are included in a particular machine will depend on the type of machine. For example, portable machines such as mobile phones may include a touch input device or other such input mechanisms, while a headless server machine will likely not include such a touch input device. It will be appreciated that the I/O components 608 may include many other components that are not shown in FIG. 6. In various examples, the I/O components 608 may include user output components 624 and user input components 626. The user output components 624 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The motion components 630 include acceleration sensor components (e.g., accelerometer), gravitation sensor components, rotation sensor components (e.g., gyroscope).

The environmental components 632 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

Communication may be implemented using a wide variety of technologies. The I/O components 608 further include communication components 636 operable to couple the machine 600 to a network 638 or devices 640 via respective coupling or connections. For example, the communication components 636 may include a network interface component or another suitable device to interface with the network 638. In further examples, the communication components 636 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 640 may be another machine or any of a wide variety of peripheral devices (e.g., a peripheral device coupled via a USB).

Moreover, the communication components 636 may detect identifiers or include components operable to detect identifiers. For example, the communication components 636 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 636, such as location via Internet Protocol (IP) geolocation, location via Wi-Fi® signal triangulation, location via detecting an NFC beacon signal that may indicate a particular location, and so forth.

The various memories (e.g., main memory 616, static memory 618, and memory of the processors 604) and storage unit 620 may store one or more sets of instructions and data structures (e.g., software) embodying or used by any one or more of the methodologies or functions described herein. These instructions (e.g., the instructions 602), when executed by processors 604, cause various operations to implement the disclosed examples.

The instructions 602 may be transmitted or received over the network 638, using a transmission medium, via a network interface device (e.g., a network interface component included in the communication components 636) and using any one of several well-known transfer protocols (e.g., hypertext transfer protocol (HTTP)). Similarly, the instructions 602 may be transmitted or received using a transmission medium via a coupling (e.g., a peer-to-peer coupling) to the devices 640.

What is claimed, is:

1. A method for routing real-time data across distributed server nodes, the method comprising:
establishing websocket connections between clients and a plurality of server nodes;
publishing connection information to a publish-subscribe service when clients establish websocket connections, the connection information associating client identifiers with server node identifiers;
maintaining, by each server node, an in-memory mapping table based on the connection information received from the publish-subscribe service;
receiving an event to be delivered to a target client;
determining a target server node by performing an in-memory lookup in the mapping table; and
forwarding the event to the target server node for delivery to the target client.

2. The method of claim 1, wherein the publish-subscribe service is implemented using Kafka, and wherein publishing the connection information comprises publishing a message to a dedicated Kafka topic that all server nodes subscribe to for receiving connection updates.

3. The method of claim 1, further comprising:
detecting a failure of a server node;
reconnecting clients previously connected to the failed server node to available server nodes; and
publishing updated connection information to the publish-subscribe service for each reconnected client.

4. The method of claim 1, further comprising:
continuing to route events using the in-memory mapping table during a temporary outage of the publish-subscribe service; and
automatically resynchronizing the in-memory mapping table when the publish-subscribe service recovers.

5. The method of claim 1, wherein maintaining the in-memory mapping table comprises:
storing the mapping table primarily in memory; and
utilizing disk storage as overflow when memory capacity is exceeded.

6. The method of claim 1, wherein:
the event comprises a real-time transcription fragment of an ongoing voice call;
the target client is an agent interface in a communications platform; and
forwarding the event enables display of the transcription fragment on the agent interface as the voice call progresses.

7. The method of claim 1, wherein:
the plurality of clients comprise contact center agents;
the events comprise real-time data selected from the group consisting of: voice call transcriptions, customer interaction analytics, and supervisor monitoring data; and
the method further comprises filtering the events at the target server node based on subscription preferences of the target client.

8. The method of claim 1, wherein:
the event comprises a financial transaction alert;
the target client is a financial trading platform interface; and
forwarding the event enables real-time notification of the financial transaction alert on the trading platform interface.

9. The method of claim 1, further comprising:
materializing a key-value table representation of the connection information from the publish-subscribe service; and
initializing the in-memory mapping table of a new server node using the key-value table when the new server node is added to the plurality of server nodes.

10. A system for routing real-time data across distributed server nodes, the system comprising:
a plurality of server nodes configured to establish websocket connections with clients;
a publish-subscribe service communicatively coupled to the plurality of server nodes;
wherein each server node of the plurality of server nodes is configured to:
publish connection information to the publish-subscribe service when clients establish websocket connections with a server node in the plurality of server nodes, the connection information associating client identifiers with server node identifiers;
subscribe to the publish-subscribe service to receive connection information published by other server nodes of the plurality of server nodes;
maintain an in-memory mapping table based on the connection information received from the publish-subscribe service;
receive an event to be delivered to a target client;
determine a target server node by performing an in-memory lookup in the mapping table; and
forward the event to the target server node for delivery to the target client via a websocket connection.

11. The system of claim 10, wherein the publish-subscribe service is implemented using Kafka, and wherein publishing the connection information comprises publishing a message to a dedicated Kafka topic that all server nodes subscribe to for receiving connection updates.

12. The system of claim 10, wherein each server node of the plurality of server nodes is further configured to:
detect a failure of a server node;
reconnect clients previously connected to the failed server node to available server nodes; and
publish updated connection information to the publish-subscribe service for each reconnected client.

13. The system of claim 10, wherein each server node of the plurality of server nodes is further configured to:
continue to route events using the in-memory mapping table during a temporary outage of the publish-subscribe service; and
automatically resynchronize the in-memory mapping table when the publish-subscribe service recovers.

14. The system of claim 10, wherein maintaining the in-memory mapping table comprises:
storing the mapping table primarily in memory; and
utilizing disk storage as overflow when memory capacity is exceeded.

15. The system of claim 10, wherein:
the event comprises a real-time transcription fragment of an ongoing voice call;
the target client is an agent interface in a communications platform; and
forwarding the event enables display of the transcription fragment on the agent interface as the voice call progresses.

16. The system of claim 10, wherein:
the plurality of clients comprise contact center agents;
the events comprise real-time data selected from the group consisting of: voice call transcriptions, customer interaction analytics, and supervisor monitoring data; and
each server node is further configured to filter the events at the target server node based on subscription preferences of the target client.

17. The system of claim 10, wherein:
the event comprises a financial transaction alert;
the target client is a financial trading platform interface; and
forwarding the event enables real-time notification of the financial transaction alert on the trading platform interface.

18. The system of claim 10, wherein each server node of the plurality of server nodes is further configured to:
materialize a key-value table representation of the connection information from the publish-subscribe service; and
initialize the in-memory mapping table of a new server node using the key-value table when the new server node is added to the plurality of server nodes.

19. One or more non-transitory computer-readable media storing instructions that, when executed by one or more processors, cause the one or more processors to perform operations for routing real-time data across distributed server nodes, the operations comprising:
establishing websocket connections between clients and a plurality of server nodes;
publishing connection information to a publish-subscribe service when clients establish websocket connections, the connection information associating client identifiers with server node identifiers;
maintaining, by each server node, an in-memory mapping table based on the connection information received from the publish-subscribe service;
receiving an event to be delivered to a target client;
determining a target server node by performing an in-memory lookup in the mapping table; and
forwarding the event to the target server node for delivery to the target client.

20. The one or more non-transitory computer-readable media of claim 19, wherein the publish-subscribe service is implemented using Kafka, and wherein publishing the connection information comprises publishing a message to a dedicated Kafka topic that all server nodes subscribe to for receiving connection updates.
